(19) United States
(12) Patent Application Publication
(10) Pub. No.: US 2026/0011954 A1
(43) Pub. Date: Jan. 8, 2026

(54) QUARTER-TURN CONNECTOR FOR CONNECTING ELECTRICAL CONDUCTORS AND CORRESPONDING CONNECTOR CONNECTION METHOD

(71) Applicant: Amphenol - Air LB, Carignan (FR)

(72) Inventors: Gaspard CAYZAC, Margut (FR); Mathias MICHEL, La Grandville (FR); Jérôme VALET, Mouzon (FR); Anthony WANSCHOOR, Sedan (FR)

(73) Assignee: Amphenol - Air LB, Carignan (FR)

(21) Appl. No.: 19/259,917

(22) Filed: Jul. 3, 2025

(30) Foreign Application Priority Data
Jul. 5, 2024 (FR) 2407363

(51) Int. Cl. H01R 13/625; H01R 43/26

(52) U.S. Cl. CPC H01R 13/625; H01R 43/26

(57) ABSTRACT

This connector for connecting electrical conductors comprises two conjugate parts, respectively male and female, each comprising a connector body made of insulating material comprising a passage in which a contact comprising an insulating contact body and a contact element, respectively a pin and a socket, is mounted. The contact body and the connector body comprise rotatably locking assembly means.

### CROSS-REFERENCE TO RELATED APPLICATION

This application is based upon and claims the benefit of priority from the prior French Patent Application No. FR2407363, filed on Jul. 5, 2024, the entire contents of which are incorporated herein by reference.

### DETAILED DESCRIPTION

The present invention relates to a lockable electrical connector for the electrical connection of conductors comprising in particular a contact tip at the end thereof to be connected.

The invention relates more particularly to a connector comprising two conjugate parts, respectively male and female.

On connectors of this type, each part of the connector generally comprises a connector body made of insulating material, a contact body, also made of insulating material, and in which a contact element is mounted, consisting of a pin, with respect to the male part of the connector, and a socket with respect to the female part of the connector.

For example, reference may be made to document FR2764127 which describes a two-part locking electrical connector.

The connectors of this type are further provided with insulation means which are in particular provided at the two conjugate male and female parts, in particular at the front part of the contact body through which the contact element is accessible and at the rear part of the connector body through which the conductor is inserted into the connector.

Generally, the contact element is inserted into the connector body and held therein using snap-locking means. As the contacts are detachable, they are retained by a retaining system with clips which are capable of spreading apart to release the contact element by inserting a pen-type tool, to release the contact element.

As designed, this type of connector must necessarily provide space for the passage of the tool unlocking the contact element.

However, the current trend, in particular with regard to aircraft powered by hybrid or hydrogen engine systems, involves carrying increased electrical power, which requires the use of increasingly large connectors and, in particular, contacts.

Current connectors generally do not allow contact elements larger than standardised size 8 to be fitted, which corresponds to currents of around 46 amps.

The aim of the invention is therefore to overcome this drawback and to provide a connector that makes it possible to mount larger contact elements, while retaining the removable character of the contact element and while retaining the insulators provided at the contact element and the connector body.

The object of the invention is therefore a connector for connecting electrical conductors, comprising two conjugate parts, respectively male and female, each comprising a connector body made of insulating material comprising a passage into which a contact comprising an insulating contact body and a contact element, respectively a pin and a socket, is mounted.

The contact body and the connector body comprise rotatably locking assembly means.

In one embodiment, the rotatably locking assembly means comprise a quarter-turn lock.

Thus, locking and unlocking the contact body in the connector body does not require inserting a tool between the connector body and the element so that it is possible to use contacts of increased dimensions, using the volume dedicated to passing the tool in the prior art.

For example, the contact body is provided externally with a helical groove in which a pin carried by the inner face of the passage made in the connector body engages.

Advantageously, the front face of the contact body is provided with an insulating sealing insert.

The rear side of the connector body may also have an insulating sealing insert.

It should be noted that the connector body may externally include snap-fit means for mounting on a connector in a housing.

Advantageously, the connector is a connector with a capacity of at least 46 amps.

The invention also relates to a method for assembling a connector as defined above, for connecting electrical conductors.

This method comprises the steps consisting in, for each part of the male and female connectors:
assembling the contact element in the contact body;
inserting the contact body into the passage of the connector body; and
locking the contact body in the connector body by rotating it.

Other aims, features and advantages of the invention will become

apparent upon reading the following description, given merely as a non-limiting example, and made with reference to the appended drawings, wherein:

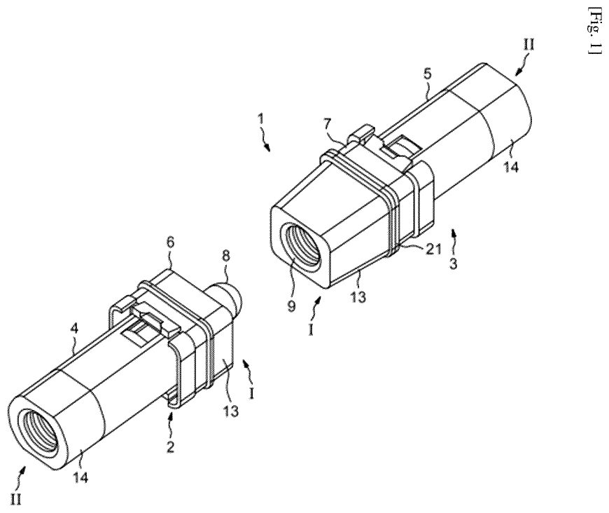

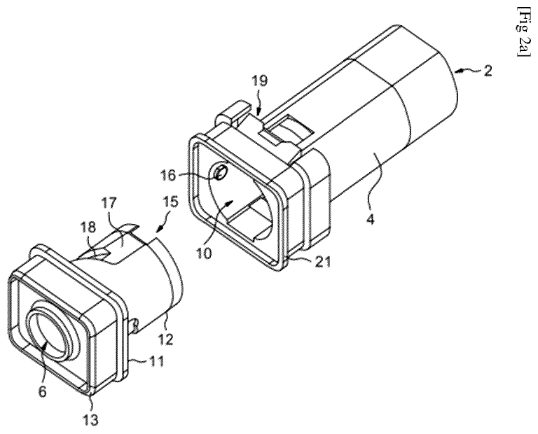

FIG. 1 is a perspective view of a connector according to the invention showing the two conjugate male and female parts:

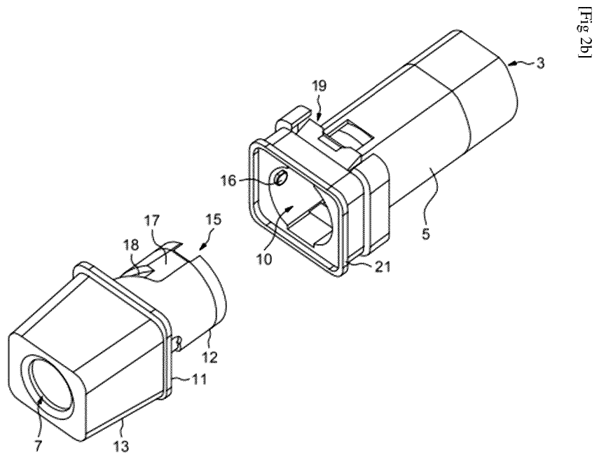

FIG. 2a and FIG. 2b illustrate the structure of the male and female parts, respectively;

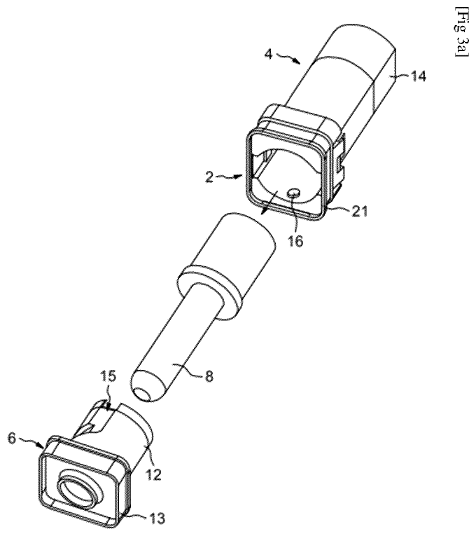

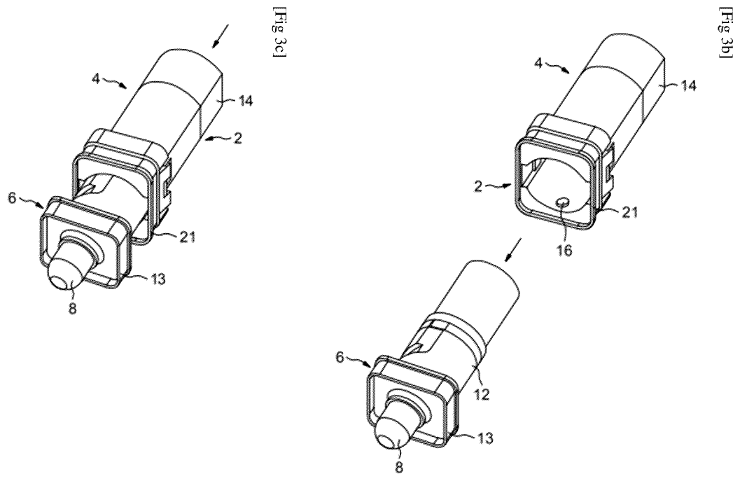

FIG. 3a, FIG. 3b, FIG. 3c, FIG. 3d and FIG. 3e illustrate the assembly of the male part of the connector according to the invention;

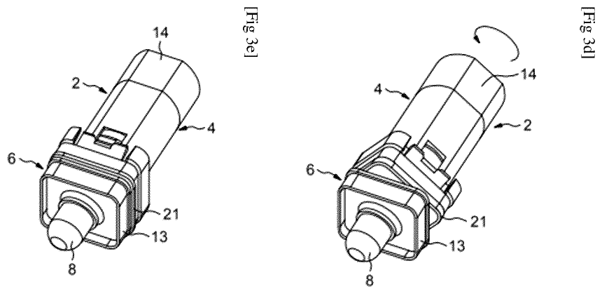

FIG. 4 is a longitudinal sectional view of a connector according to the invention;

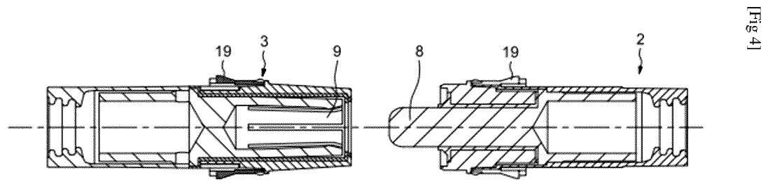

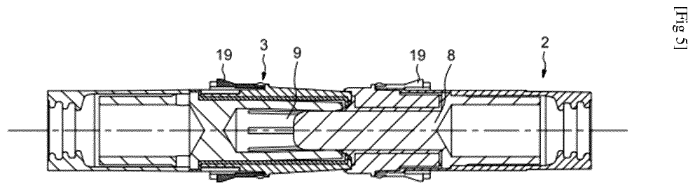

FIG. 5 shows the connector of FIG. 4 in the connection position; and

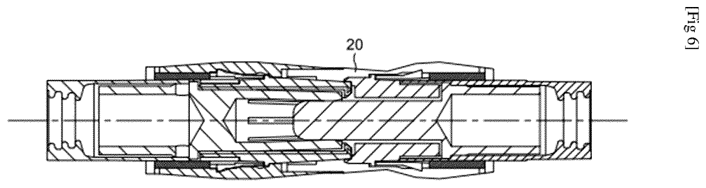

FIG. 6 illustrates the connector of FIG. 5 mounted in a housing.

First, reference will be made to FIGS. 1, 2a and 2b which illustrate a connector according to the invention, designated by the general numerical reference 1.

Such a connector is intended to ensure the electrical connection of electrical conductors of an on-board electrical network of an aircraft.

In particular, it is intended to ensure the connection of electrical conductors in which currents of up to and even more than 46 amps flow.

This is a connector that accommodates a standardised contact size of at least 8.

As illustrated in the figures, the connector according to the invention comprises two conjugate parts, namely a male part 2 and a female part 3.

The male and female parts are each intended to receive a conductor comprising an end to be connected to a contact tip. As illustrated, the male and female parts include an anterior end I through which the two connector parts are mated, and a posterior end II through which a conductor is inserted into the connector.

Each part 2 and 3 of the connector includes a connector body 4 and 5 made of insulating material and a contact consisting of a contact body 6 and 7 made of insulating material and a contact element 8 and 9 being mounted in an axial passage 10 made in the connector body.

With regard to the male part, the contact element 8 consists of a pin.

With regard to the female part, the contact element 9 consists of a socket into which the corresponding pin is inserted, during the electrical connection.

The insulating contact body 4 and 5 of the male and female parts 2 and 3 includes a shoulder 11, a cylindrical extension 12 extending from the shoulder 11 and an insulating sealing insert 13 mounted on the shoulder 11, on the anterior side.

A complementary insulating sealing insert 14 is also provided at the rear end of the connector body of each part 2 and 3 to ensure sealing around the conductor.

The sealing inserts provide electrical insulation and also watertightness when the male and female parts of the connector are mated.

Complementary sealing means are provided, comprising a seal 21 that ensures the sealing between the connector and the housing 20 (FIG. 6), as well as a nipple on the male insulating contact body that ensures the sealing between the male and female parts.

With regard to the male part, the pin is mounted from the posterior side to extend protruding, from the anterior side, through the insulating sealing insert 13.

With regard to the female part, the socket 9 is accessible through a passage made in the insulating sealing insert 13.

As illustrated in FIGS. 2a and 2b, the male and female parts of the connector are provided with rotatably locking assembly means.

These are assembly means that ensure the locking of the conjugate connector parts by a relative rotational movement.

Advantageously, it is a quarter-turn lock.

In the embodiment illustrated in FIGS. 2a and 2b, the axial cylindrical extension 12 of the contact body of the male and female parts is provided with a helical groove 15 while the passage 10 of the connector body includes a radial point 16 which is intended to be inserted into the helical groove 15.

Of course, the groove could be made in the passage 10 of the connector body and the pin carried by the axial cylindrical extension 12, without departing from the scope of the invention.

As illustrated, this groove includes an axial portion 17 extended by a helical portion 18. With reference to FIGS. 3a to 3c, with regard to the male connector part, the assembly of the connector is carried out by first inserting the pin 8 into the contact body 6 and then inserting the assembly into the connector body 4 ensuring the locking of the assembly by quarter-turn locking (FIGS. 3c to 3e). The female part is assembled in a similar sequence, by also inserting the socket into the contact body and then inserting the assembly into the connector body 5 ensuring the locking of the assembly by quarter-turn locking.

As illustrated in 2a and 2b, the connector body is provided externally with snap-fit means comprising tabs, such as 19, which snap into corresponding indentations in order to lock the assembled connector in a housing 20.

For example, it may be an electromagnetic shielding box.

While illustrative embodiments have been illustrated and described, it will be appreciated that various changes can be made therein without departing from the spirit and scope of the invention.

The embodiments of the invention in which an exclusive property or privilege is claimed are defined as follows:

1. Connector for connecting electrical conductors, comprising two conjugate parts, male and female respectively, each comprising a connector body made of insulating material comprising a passage in which a contact comprising an insulating contact body and a contact element is mounted, respectively a pin and a socket, characterised in that the contact body and the connector body comprise rotatably locking assembly means.

2. Connector according to claim 1, wherein the assembly means comprises a quarter-turn lock.

3. Connector according to claim 2, wherein the contact body is provided externally with a helical groove in which a pin carried by the inner face of the passage made in the connector body engages.

4. Connector according to claim 1, wherein the front face of the contact body is provided with an insulating sealing insert.

5. Connector according to claim 1, wherein the rear face of the connector body is provided with an insulating sealing insert.

6. Connector according to claim 1, wherein the connector body includes externally snap-fit means for mounting the connector in a housing.

7. Connector according to claim 1, wherein the connector is a connector with a capacity of at least 46 amps.

8. Method for assembling a connector according to claim 1, for connecting electrical conductors, characterised in that it comprises the steps of, for each male and female connector part:
assembling the contact element in the contact body;
inserting the contact body into the passage of the connector body; and
locking the contact body in the connector body by rotating it.
